(19) United States
(12) Patent Application Publication
(10) Pub. No.: US 2026/0367950 A1
(43) Pub. Date: Nov. 19, 2026

(54) SYSTEM, METHOD, AND COMPUTER PROGRAM FOR IMPLEMENTING CLOUD NATIVE VIRTUAL PHONE

(71) Applicant: HYPORI, INC., Reston, VA (US)

(72) Inventors: Eric WANG, Reston, VA (US); Sanjay MIJAR, Reston, VA (US); Matt ESPER, Reston, VA (US); Phani ACHANTA, Reston, VA (US); Salman DHEDHI, Reston, VA (US)

(21) Appl. No.: 19/681,847

(22) Filed: May 19, 2026

Related U.S. Application Data
(60) Provisional application No. 63/808,337, filed on May 19, 2025.

(51) Int. Cl. G06F 9/455; G06F 3/01; G06F 9/50; H04L 9/40

(52) U.S. Cl. CPC G06F 9/455; G06F 3/017; G06F 9/5077; H04L 63/0823; G06F 2209/5011

(57) ABSTRACT

A system, method, and apparatus for implementing a cloud native virtual phone are provided. The system may include a mobile device executing a dedicated client application, a virtual workspace hosted on a cloud server and isolated from the mobile device, and a control plane managing the lifecycle of the virtual workspace. The mobile device may forward user input to the virtual workspace and receive display output therefrom, such that no enterprise data is persisted at rest on the mobile device. The virtual workspace may process enterprise applications and data, and transmit encrypted pixel data representing a mobile device interface to the mobile device. In certain embodiments, network traffic may be confined to separate network segments for display, enterprise, and management communications. The virtual workspace may additionally support telephony capabilities including voice over IP and eSIM functionality, providing a full mobile phone experience in the cloud.

### CROSS REFERENCE TO RELATED APPLICATION

This application is related to and claims the priority of U.S. Provisional Patent Application No. 63/808,337, filed May 19, 2025, which is hereby incorporated herein by reference in its entirety.

### FIELD

This disclosure relates generally to a virtual mobile device platform. More particularly, embodiments disclosed herein relate to a system, method, and computer program product that provides a cloud native virtual phone.

### BACKGROUND

Today's mobile devices like smartphones and tablets face significant security challenges, particularly in environments like enterprises and military agencies where users often mix personal and business activities on their devices, complicating security even with Bring Your Own Device (BYOD) policies.

Issues arise when personal devices access sensitive networks; for instance, if a device is lost, unsecured data could be compromised. Additionally, when an employee leaves, company data may remain on their personal device. Organizations must develop clear policies outlining what sensitive information needs protection and who should access it, while educating employees on these policies. Some risk-averse organizations prefer “Inverse-BYOD,” issuing devices solely for internet use, but this often requires users to carry multiple devices and doesn't prevent them from sharing company-related information using personal devices. High assurance computing environments require strict security measures, including certified applications for accessing sensitive data.

However, physical devices remain vulnerable to theft, loss, and infection, as secured hardware and encryption can be costly and may not prevent sophisticated attacks. As securing mobile devices in hostile environments is challenging, there is a clear need for innovations in this area, including a zero-trust architecture mobility solution that isolates multiple profiles from each other on a single mobile device and providing access, as necessary, to enterprise applications and data via a separate, secure virtual device. For example, separating work applications containing corporate/enterprise data away from any physical device including personal phones.

Existing solutions either attempt to secure enterprise data and applications that are processed and stored on a user’s mobile device, exposing them to the aforementioned threats and – by means of enterprise control exerted over the device – invading users’ privacy; or attempt to keep data in a remote location controlled by the enterprise, but fail to offer users a way of engagement and interaction that they expect from mobile devices and applications (for example, using touch screens, mobile application, and screens optimized for pocket-sized displays

In view of unique challenges in incorporating mobile devices such as smart phones and tablets into secure computing environments, there is room for innovations and improvements.

### SUMMARY

Some example embodiments may be directed to a method performed by a virtual workspace. The method may include establishing, by a virtual workspace hosted on a cloud server, a connection with a mobile device via a dedicated client application executing on the mobile device and a connection with a control plane managing a lifecycle of the virtual workspace; receiving user input forwarded from the mobile device comprising gesture data and sensor data from input peripherals of the mobile device; processing enterprise applications and data at the virtual workspace based on the received user input; and transmitting display output comprising encrypted pixel data representing a mobile device interface to the mobile device, wherein no enterprise data is persisted at rest on the mobile device.

Other example embodiments may be directed to an apparatus. The apparatus may include at least one processor and at least one memory storing instructions which, when executed by the at least one processor, cause the apparatus to at least: establish a connection with a mobile device via a dedicated application implemented on the mobile device and a connection with a control plane, wherein the apparatus is hosted on a cloud server and is isolated from the mobile device; receive user input forwarded from the mobile device comprising gesture data and sensor data from input peripherals of the mobile device; process enterprise applications and data such that no enterprise data is persisted at rest on the mobile device; and transmit display output to the mobile device representing a mobile device interface executing on the apparatus.

Other example embodiments may be directed to an apparatus. The apparatus may include means for establishing a connection with a mobile device via a dedicated application implemented on the mobile device and means for establishing a connection with a control plane, wherein the apparatus is hosted on a cloud server and is isolated from the mobile device; means for receiving user input forwarded from the mobile device; means for processing enterprise applications and data such that no enterprise data is persisted at rest on the mobile device; and means for transmitting display output to the mobile device representing a mobile device interface executing on the apparatus.

Other example embodiments may be directed to a cloud native system. The cloud native system may include a mobile device, a virtual workspace including a connection with the mobile device via a dedicated application implemented on the mobile device, and a control plane configured to manage the virtual workspace. According to certain example embodiments, the mobile device forwards user input to the virtual workspace via the dedicated client application, and no enterprise data is persisted at rest on the mobile device. In certain embodiments, network traffic between the mobile device and the virtual workspace is confined to a first network segment, network traffic between the virtual workspace and enterprise resources is confined to a second network segment distinct from the first, and management traffic between the control plane and the virtual workspace is confined to a third network segment, such that no direct communication path exists between the mobile device and the enterprise resources.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 illustrates an example multiple control plane (CP) in a cloud agnostic deployment for managing of managed virtual machines, according to certain embodiments.

FIG. 2 illustrates an example system with multiple Amazon Web Services (AWS) regions and availability zones, according to certain embodiments.

FIG. 3 illustrates an example of a virtual workspace (WS) configuration running on AWS EC2 infrastructure, according to certain embodiments.

FIG. 4 illustrates an example detailed version of FIG. 3, according to certain embodiments.

FIG. 5 illustrates an alternative of FIG. 3, according to certain embodiments.

FIG. 6 illustrates another alternative of FIG. 3, according to certain embodiments.

FIG. 7 illustrates an example of application management for multiple applications made available to WSs, according to certain embodiments.

FIG. 8 illustrates an example system architecture, according to certain embodiments.

FIG. 9 illustrates an example WS instance state transitions with CP orchestration, according to certain embodiments.

FIG. 10 illustrates an example of WS instance states in relation with cloud cost, according to certain embodiments.

FIG. 11 illustrates an example of CP with Kubernetes, according to certain embodiments.

FIG. 12 illustrates an example Kubernetes-based microservices architecture for implementing the control plane, according to certain embodiments.

FIG. 13 illustrates a transport layer security architecture, according to certain embodiments.

FIG. 14(a) illustrates an example architecture of a system, according to certain embodiments.

FIG. 14(b) illustrates an example architecture of another system, according to certain embodiments.

FIG. 14(c) illustrates an example architecture of another system, according to certain embodiments.

FIG. 14(d) illustrates an example architecture of another system, according to certain embodiments.

FIG. 15 illustrates an example flow diagram of a method, according to certain embodiments.

FIG. 16 illustrates an example apparatus, according to certain embodiments.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions, and/or rearrangements within the spirit and/or scope of the underlying inventive concept will become apparent to those skilled in the art from this disclosure.

According to certain embodiments, it may be possible to provide a cloud agnostic mobile virtual workspace solution to provide secure remote access across applications and data (“system”).

As described above, a mobile device lives in a hostile world and, as such, securing the device itself may not be enough and/or possible. There is a need for a cloud agnostic mobile virtual workspace solution to provide secure remote access to enterprise applications and data (“system”). The system may be comprised of any mobile device (MD), a virtual workspace (hereinafter interchangeably referred to as “WS” or “VW”) accessed from the MD and a control plane (CP) managing WS.

In certain embodiments, the MD may reside with the user and may be connected to one or more public and/or private data networks for communication, and be able to roam (e.g., accompany the user to different locations and connect to available networks accordingly). However, in a different embodiment, the MD may not permanently be associated with a specific user and/or may be static in location and/or connectivity, such as a hand-held device or terminal shared between multiple users and/or installed in a public space. On the contrary, WS and CP may be centrally managed, in the sense that a service provider or enterprise – as opposed to the individual user – are able to exercise physical (location) and logical (configuration, communication paths, etc.) control over them.

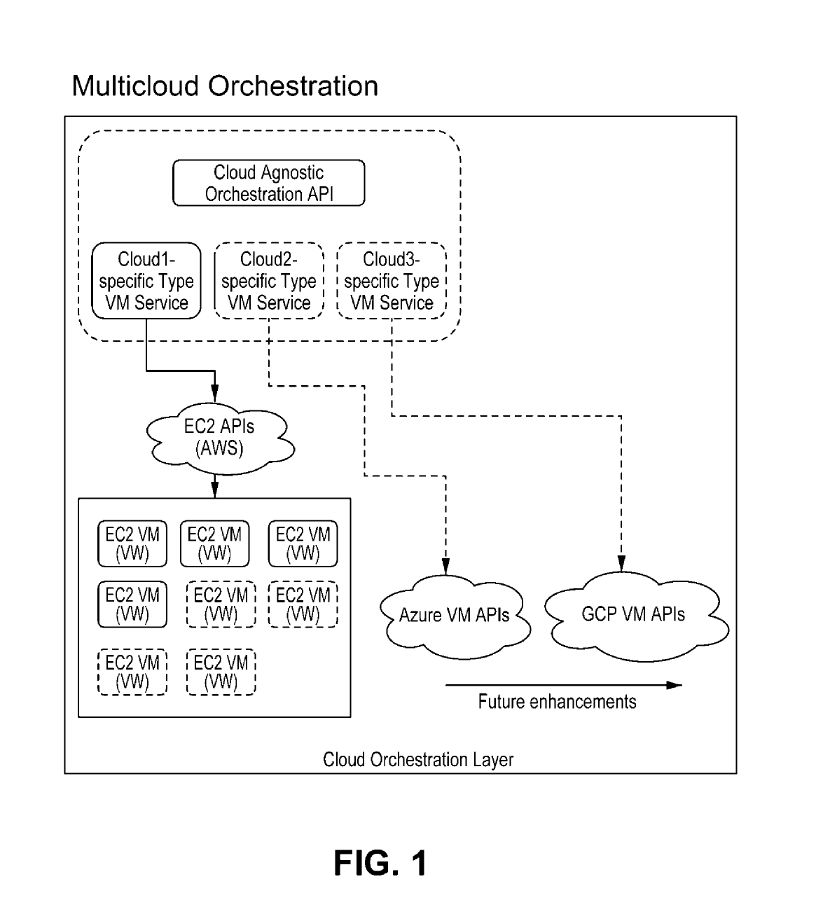

FIG. 1 illustrates an example multiple CP in a cloud agnostic deployment for managing a virtual Workspace (WS), according to certain embodiments. In particular, FIG. 1 illustrates that the cloud agnostic deployment is across multiple environments. For instance, as illustrated in FIG. 1, the CP may associate the user with a group, which may or may not equate to a particular customer or department.

FIG. 1 illustrates an example of cloud-agnostic deployment across multiple environments, according to certain embodiments. As illustrated in FIG. 1, CP may associate the user with a group, which may or may not equate to a particular customer or department. The group may, by default, be associated with some cluster. In certain embodiments, a wizard may be added in compose to initialize lightweight directory access protocol (LDAP) database (DB), and deployment may occur in k8s. In certain embodiments, access logs style lines may be added for calls.

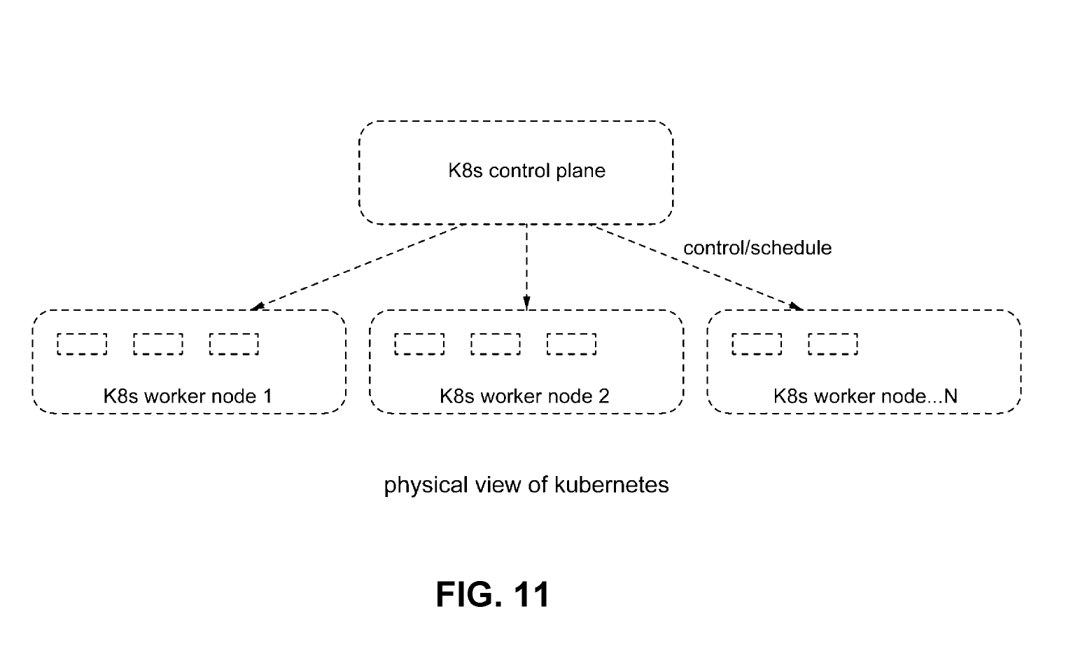

According to certain embodiments, during a user’s MD onboarding flow, a conventional verification mechanism, such as, for example, a onetime password (OTP), may be issued, and the user may onboard their MD to the account provisioned by the CP. The WS may be allocated for the user by the CP, and the WS lifecycle states (e.g., shown in FIG. 11) may be managed by the CP for the user.

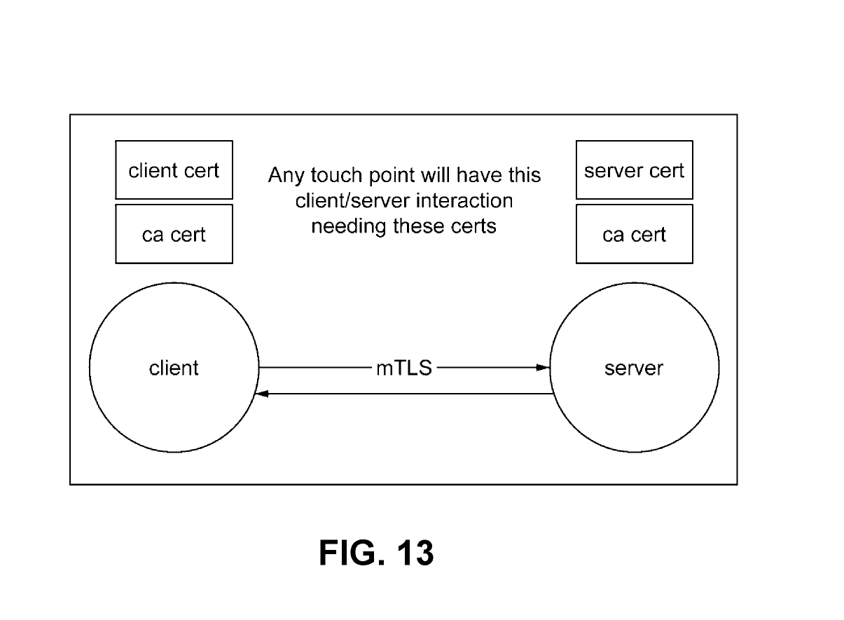

In certain embodiments, the user may access their WS in various ways. For instance, in certain embodiments, the user may access the WS via a client through an authentication service for authentication flow, and/or may be issued a token by the CP where the token may contain information about how to connect to the WS. In other embodiments, the MD and CP may use any conventional intermediary for handling secure/encrypted connections between these two components, such that features such as, for example traffic inspection and forwarding of MD session context or connection information can be provided. In some embodiments, the intermediary may be a proxy, and the MD (e.g., client) may attempt to connect to the proxy with mutual TLS (mTLS), as illustrated in FIG. 13) and with the token with WS connection information represented via information such as server name indication (SNI). In certain embodiments, the TLS proxy may attempt to resolve a DNS entry for WS and make a connection to the WS.

According to certain embodiments, the CP may provide the WS with locatable domain name system (DNS), allowing the CP and underlying network infrastructure to route traffic from the MD to the WS accordingly. In other embodiments, the WS lifecycle may be managed through the CP. For instance, an application programming interface (API) may be added for WS management and externalized, forwarding state requests to the appropriate microservice in the CP via an event bus for WS lifecycle management.

In certain embodiments, the cloud provider (for example EC2 (elastic compute cloud)) illustrated in FIG. 1 may provide web services that provide resizable computing capacity for WS in the cloud. This may provide a scalable and on-demand computing resource without the need for exchanging different physical hardware.

According to certain embodiments, when the WS is starting up, the cloud provider does not immediately begin operations upon the WS startup. Instead, there is a latency period or pending time that needs to elapse before the WS compute instance starts up. The time that the cloud provider needs to setup a WS instance for the user may vary such as, for example, between 2 to 30 seconds. As such, when a user connects to their WS from their MD, an extended delay may occur. This extended delay may result in delays in user getting into their WS. When user disconnects from the WS from the MD, the CP may shutoff or enable hibernation for the WS after a configurable elapsed period.

In view of the startup latency, instead of starting the WS from scratch, the user data volume may be hot-attached to a partially-booted compute instance selected from a pool of compute instances maintained by the CP. The user data volume may be a persistent disk associated with a specific user and may contain user-specific applications, settings, customizations, and data; in certain embodiments, the user data volume may also contain hibernated memory state from a prior WS session, stored in a dedicated partition or file within the user data volume. The system disk of the compute instance may contain operating system (OS)-related data, while the user data volume may carry the user identity and context. According to certain example embodiments, the hot-attach operation may be performed at the OS level using cloud-provider APIs and is supported by all major cloud providers, making the mechanism cloud-agnostic. Following hot-attachment, the WS 2820 may proceed with the boot process, restore any hibernated state present in the user data volume, complete a secure boot sequence, and apply applicable policies before opening for connections from the MD 2805. The total time for this process -- including OS initialization to the hot-attach ready state, the hot-attach operation itself, hibernation state restoration (if any), and service startup -- may be on the order of approximately 2 to 5 seconds, which may be significantly less than the time required to provision and fully boot a new cloud compute instance from scratch (which may range from approximately 2 to 30 seconds). By doing so, it may be possible to avoid the extended delay time exhibited by current WS startups.

In certain embodiments, the user’s WS may only start successfully if a secure boot process is successful. WS CP may use aspects of the secure boot process to determine whether a WS is authentic, and thus should be admitted to the pool of WSs accessible by users via their MD. In certain embodiments, this will allow CP to independently establish trust into the WS without having to rely on underlying operational and/or cloud infrastructure. Certain embodiments of the secure boot process may use data unique to users and/or an individual WS to authenticate the WS, and the process may or may not use cloud infrastructure-provided “out of band” services and/or dedicated communication channels to pass on relevant parameters, such as the AWS Instance Metadata Service.

Further embodiments may provide secure boot flow analysis where the secure boot flow may be an extended flow/interaction as a result of which the WS may gain a secure identity so that it can call CP APIs. According to certain embodiments, the flow may also prepare the WS with appropriate client CA certificates so that a GRPC server may verify incoming GRPC connections.

According to certain embodiments, the WS may utilize virtual network adapters to connect to a network. The virtual network adapters on the WS may appear to be unique physical adapters. Because each session may be assigned to a different compute instance selected from the pool, the virtual network adapters of the new compute instance may have different virtual hardware identifiers -- such as MAC addresses or device IDs -- than those present during the prior session. Without intervention, this difference may cause the WS operating system and applications to behave inconsistently with respect to network configuration.

According to certain example embodiments, to ensure consistent network behavior across compute instance assignments, the WS 2820 may proactively uninstall the virtual network adapters using OS-level kernel module removal operations prior to entering a hibernation or shutdown state. This process may be self-initiated by the WS 2820 without requiring intervention from the cloud provider or the control plane. Upon assignment to a new compute instance from the pool, the WS 2820 may associate the new compute instance's virtual network adapters by loading the appropriate kernel modules using OS-level module loading operations. Because the WS 2820 treats virtual network adapters as standard network adapters regardless of the underlying cloud provider, this mechanism is cloud-agnostic and does not depend on cloud-provider-specific APIs for the adapter swap. Following the association of the new virtual network adapters, the WS 2820 may reinitialize network-dependent services -- including dynamic host configuration protocol (DHCP), network configuration, and network time protocol (NTP) -- to restore full network connectivity. Thus, in certain example embodiments, it may be possible to maintain consistent operations and functionalities at the WS 2820 regardless of changes in compute instance configuration. Thus, in certain embodiments, it may be possible to maintain operations and functionalities at the WS regardless of new compute capacity configuration.

In certain example embodiments, the control plane (CP) 2825 may identify and associate the correct user data volume with the correct compute instance during the hot-attach process by comparing unique identifiers embedded in the WS system image -- such as a kernel version identifier, an image hash, a universally unique identifier (UUID) embedded in the system image at build time, or a build-time globally unique identifier (GUID) -- against identifiers associated with the user data volume. A mismatch between these identifiers may indicate that the user data volume is being attached to a different compute instance than the one from which it was previously detached, enabling the CP or the WS to perform appropriate reconfiguration steps before completing the session establishment.

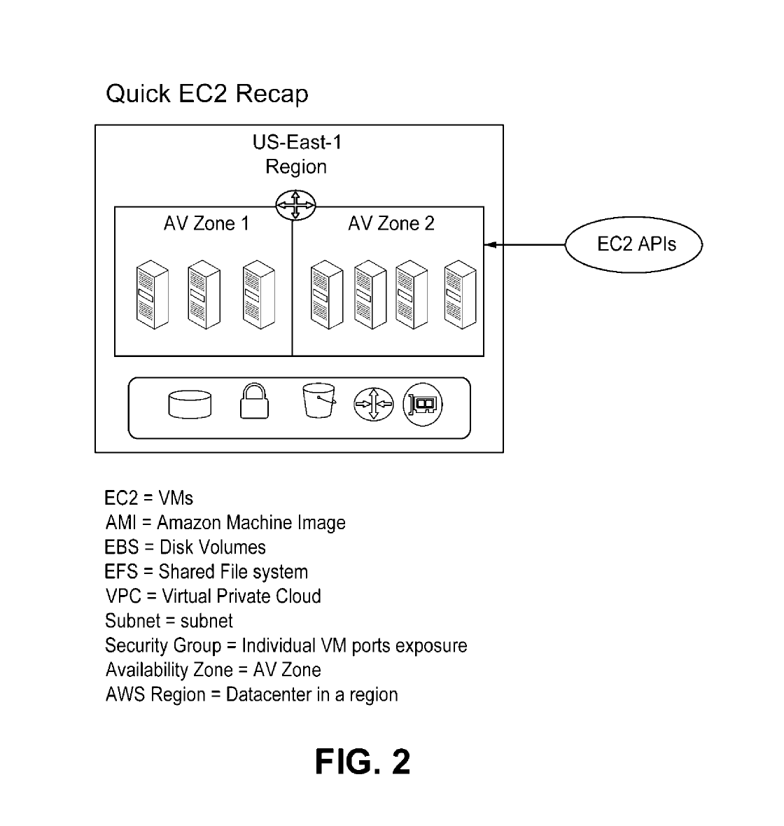

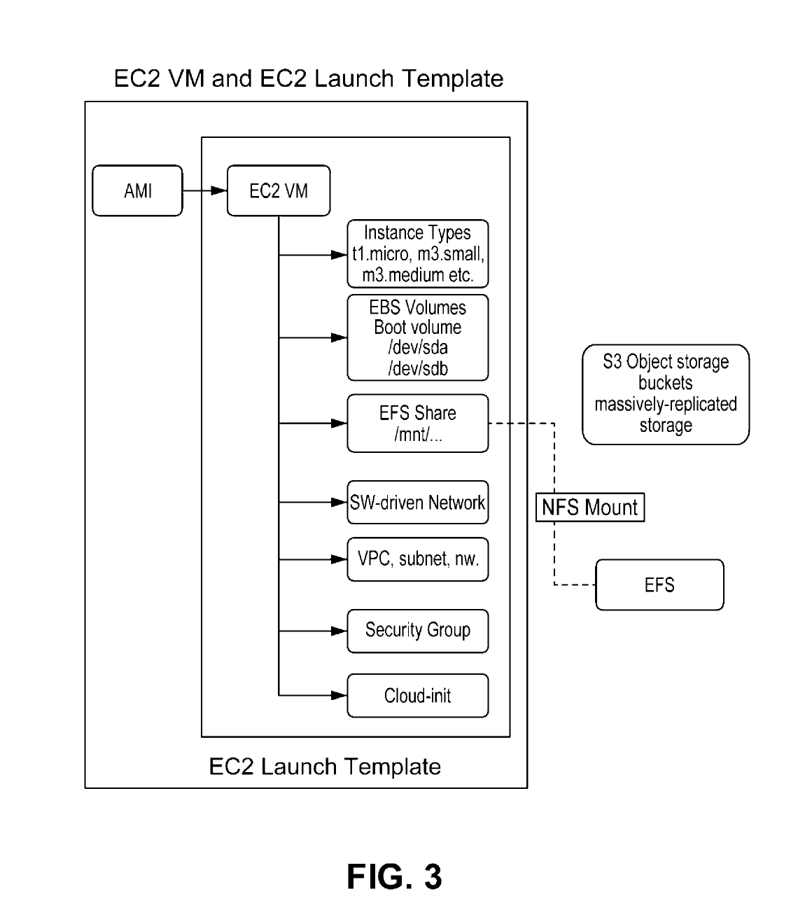

FIG. 2 illustrates an exemplary embodiment of the system with multiple AWS regions and availability zones, according to certain embodiments. FIG. 3 illustrates a WS configuration running in an AWS EC2 infrastructure, according to certain embodiments. For example, as illustrated in FIG. 3, the WS con figuration may include an Amazon Machine Image (AMI) which may serve as a pre-configured template or used to launch virtual servers, known as EC2 instances. Each AMI may include a block device mapping that specifies a block device to attach to the instances that are launched. For instance, an AMI may be specified when launching an instance, and the AMI may be compatible with the instance type that was selected for the instance. The AMI may include an operating system (e.g., Linux, Windows, etc.), installed software, configuration settings, application code, and startup instructions. As illustrated in FIG. 3, the EFS may be managed by the network file system (NFS), where the EFS may expose storage using an NFS protocol.

As further illustrated in FIG. 3, the EC2 VM may be configured with a selectable instance type — including, for example, t1.micro, m3.small, m3.medium, or other available instance types corresponding to differing compute and memory capacities — one or more EBS volumes mapped to device paths such as /dev/sda (boot volume) and /dev/sdb (additional data volume), an EFS share mounted at a configurable path (such as /mnt/...) via an NFS mount, a software-defined network interface, VPC and subnet configuration, a security group policy, and a cloud-init initialization service for runtime provisioning. The EC2 VM may additionally connect to S3 object storage providing massively-replicated bucket storage for application artifact distribution, from which application bundle content is propagated to the EFS share via NFS for access by running VM instances.

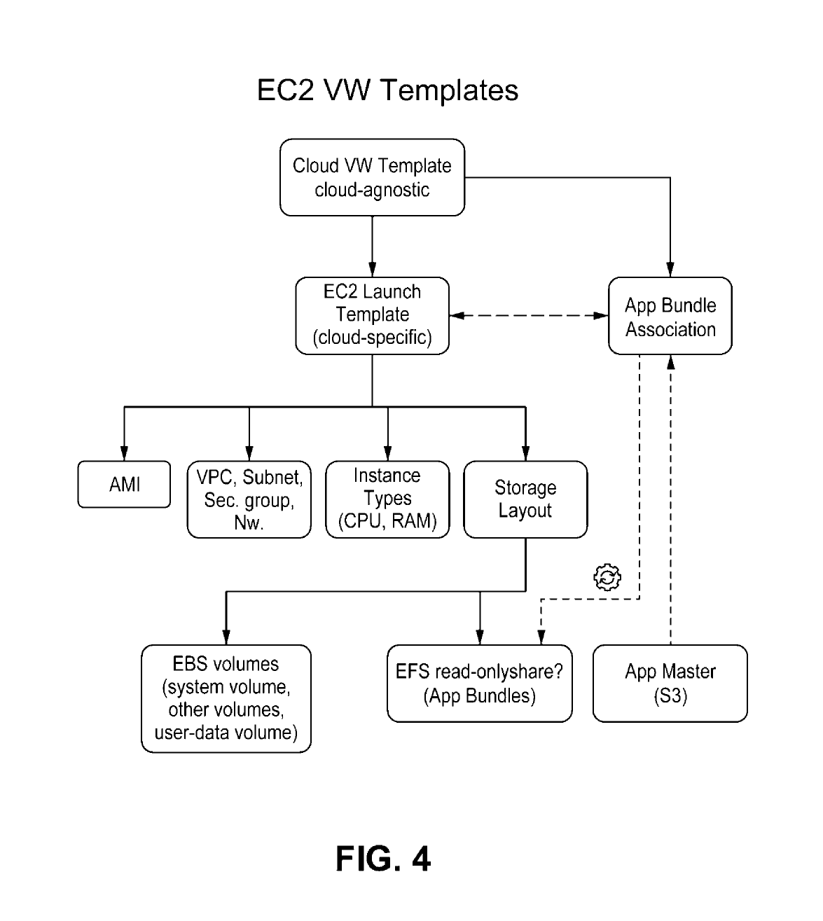

FIG. 4 illustrates a detailed version of FIG. 3 with application management, according to certain embodiments. For example, FIG. 4 illustrates a layered architecture for deploying a cloud VW environment on EC2 VW launch templates, shared storage, and application bundle associations. The layered architecture separates a cloud-agnostic VW definition from the AWS-specific deployment configuration required to instantiate infrastructure, and is centered around the cloud VW template (cloud-agnostic) and EC2 launch template (cloud-specific). The cloud-agnostic template may define the logical VW model independent of infrastructure provider details, while the EC2 launch template may materialize that model into AWS-native infrastructure configuration.

According to certain embodiments, the cloud VW template (cloud-agnostic layer) may act as the top-level portable workspace specification encapsulating workspace identity, application requirements, logical storage intent, user environment metadata, logical storage intent, user environment metadata, app bundle relationships, and deployment policy. This layer may avoid direct dependency on AWS implementation details, enabling portability across cloud providers or runtime environments. Additionally, the cloud VW template feeds into an AWS-specific EC2 launch template and an application bundle association layer.

As illustrated in FIG. 4, the EC2 launch template (cloud-specific) may represent the AWS-native infrastructure realization of the workspace, and may translate the abstract workspace definition into concrete deployment parameters required to instantiate EC2 instances. The EC2 launch template may govern compute configurations including EC2 instance family/type, CPU/RAM sizing, and hardware capabilities. The EC2 launch template may also govern network configuration including, for example, VPC, subnet selection, security groups, and networking policies. Additionally, the EC2 launch template may govern machine images including, for example, AMI selection, base operating system, and preinstalled runtime environment. Further, the EC2 launch template may govern storage layout including, for example, filesystem topology, elastic block store (EBS) mappings, and EFS integration.

In certain embodiments, the App Master (S3) may function as an authoritative application artifact storage, software package source-of-truth (e.g., a centralized, authoritative repository or location where a specific piece of data, configuration, or software package may stored, managed, and deemed the only correct version), or a deployment staging repository. Additionally, the App Master (S3) may be responsible for storing application bundles, versioned software artifacts, deployment metadata, and/or package manifests

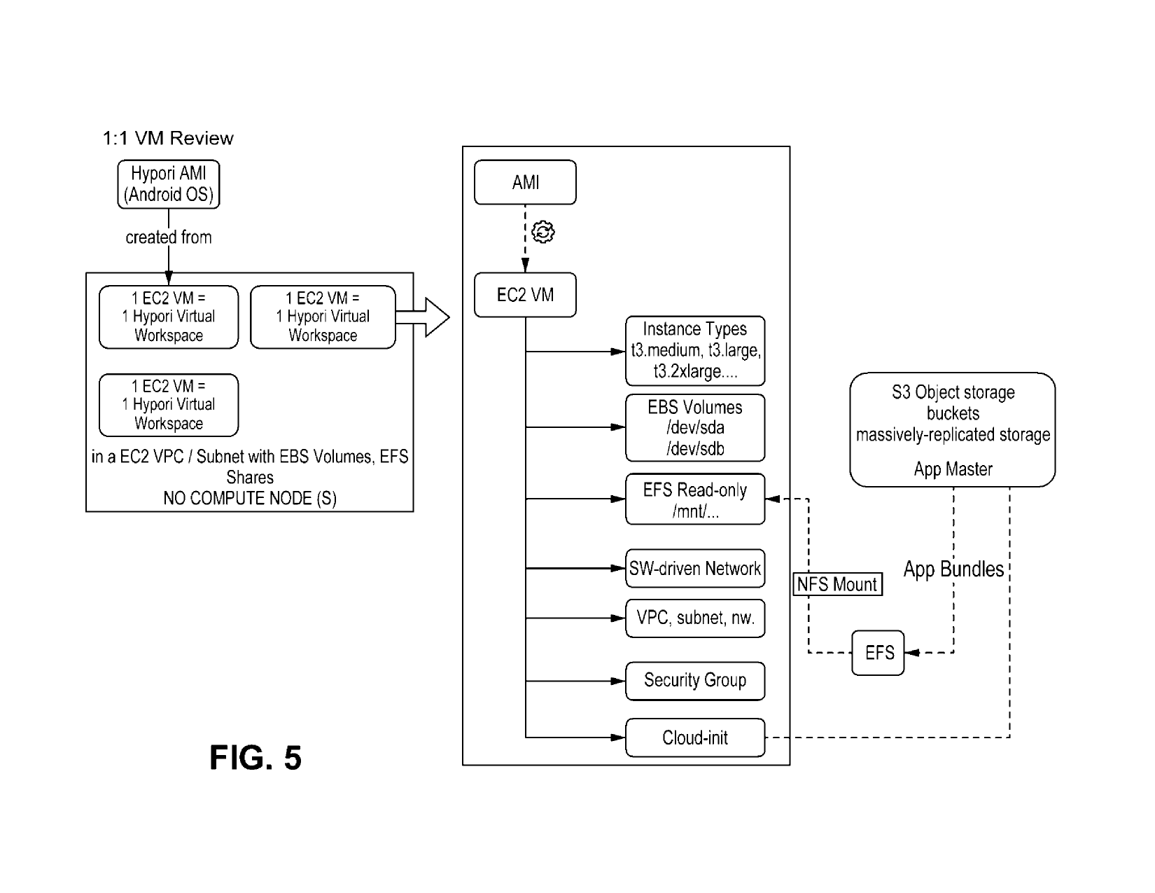

FIG. 5 illustrates an alternative illustration of FIG. 3, according to certain embodiments. For instance, FIG. 5 illustrates an example architecture and deployment model for provisioning one or more cloud-hosted VWs using VM instances, shared storage resources, and a centralized application bundle distribution.

As illustrated in FIG. 5, a VW environment may be instantiated from a machine image, such as a Hypori AMI corresponding to an Android-based operating system environment. In the illustrated embodiment of FIG. 5, each instantiated compute instance may correspond to a single VW, such that a one-to-one mapping exists between an EC2 VM instance and a VW session.

The left portion of the example architecture in FIG. 5 illustrates multiple independently instantiated EC2 VMs provisioned within a virtual private cloud (VPC) and associated subnet environment. Each VM may include attached block storage volumes and access to shared file storage resources. In certain embodiments, no separate compute node layer is required beyond the instantiated VM infrastructure.

The central portion of the architecture in FIG. 5 illustrates an example VM configuration stack associated with a deployed EC2 VM, similar to that shown in FIG. 3. The VM may be instantiated from an AMI, which may define an initial operating system state and runtime environment.

The instantiated VM may further include one or more configurable infrastructure components, including selectable instance types corresponding to differing compute and memory capacities, attached block storage devices, including EBS-backed volumes mapped to device paths, one or more shared filesystem mounts implemented using an elastic file System (EFS), software-defined networking configuration, VPC and subnet configuration, security group policy definitions;, and cloud-init or equivalent initialization services for runtime provisioning and configuration.

In some embodiments, the EFS share may be mounted as a read-only filesystem accessible to multiple VM instances. The shared filesystem may expose application bundles, executable binaries, libraries, configuration assets, or other deployment artifacts to instantiated VWs using NFS semantics, including NFS-based mounts.

The right portion of the architecture in FIG. 5 illustrates an application management and distribution subsystem. Application bundles may be maintained within an application master repository implemented using Amazon Simple Storage Service (S3) object storage buckets. In certain embodiments, the S3 repository provides massively replicated object storage for application package persistence and distribution.

In certain embodiments, application bundle artifacts may be synchronized, replicated, or otherwise propagated from the application master repository to the shared EFS filesystem. VM instances may thereafter access the application bundles through mounted EFS shares without embedding the applications directly into the AMI image. In further embodiments, cloud-init or related provisioning logic may coordinate retrieval, mounting, or configuration of application bundles during VM initialization. The architecture may thereby enable scalable deployment of isolated WSs with a centrally managed application distribution and shared storage semantics across multiple instantiated compute environments.

As noted in FIG. 5, the architecture implements a strict one-to-one mapping between EC2 VM instances and Hypori Virtual Workspaces, such that each instantiated compute instance corresponds to exactly one WS session. The WS may be instantiated from a Hypori AMI based on the Android operating system. In certain embodiments, no separate compute node layer is required beyond the instantiated VM infrastructure itself, as the EC2 VMs serve directly as the Virtual Workspace instances. This simplifies the deployment architecture and eliminates an additional infrastructure management tier while preserving full cloud-native scalability.

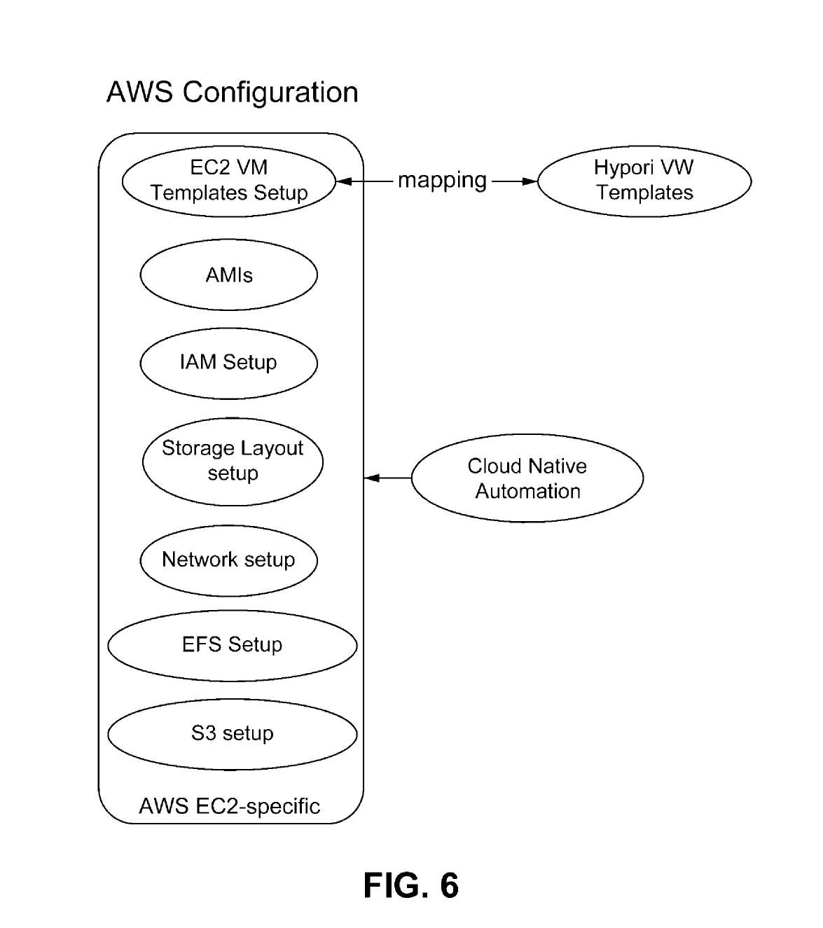

FIG. 6 is another alternative illustration of FIG. 3, according to certain embodiments. In particular, FIG. 6 illustrates an example architecture for configuring and provisioning an AWS-based cloud environment for deployment of VM workloads. As illustrated in FIG. 6, an AWS EC2-specific configuration framework may include a plurality of configuration components, including an EC2 VM template setup module, AMI configuration, identity and access management (IAM) setup, storage layout setup, network setup, EFS setup, and S3 setup.

In the example embodiment of FIG. 6, the EC2 VM template setup module may be communicatively associated with a corresponding set of Hypori-VM templates through a mapping relationship, thereby enabling translation or correlation between Hypori-VW templates and AWS EC2 template configurations. FIG. 6 also illustrates a cloud-native automation component configured to interact with the AWS EC2-specific configuration framework. According to certain embodiments, the cloud-native automation component may automate provisioning, orchestration, deployment, or management of one or more of the illustrated AWS configuration components, including, for example, storage, networking, identity management, and compute template setup.

In certain embodiments, the AWS EC2-specific configuration framework illustrated in FIG. 6 may additionally include an identity and access management (IAM) setup component configured to establish appropriate cloud access roles, policies, and permissions for the WS and CP components, following a principle of least privilege. The Cloud Native Automation component illustrated in FIG. 6 may specifically coordinate the storage layout setup, automating the creation and configuration of EBS volumes, EFS file systems, and S3 bucket policies required for workspace deployment.

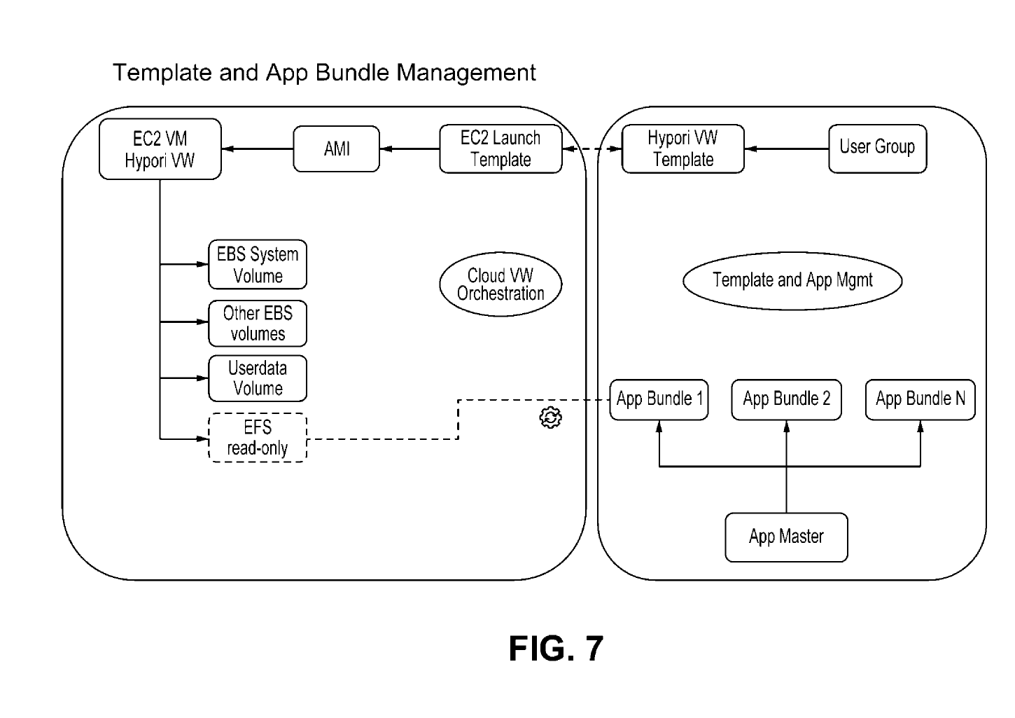

FIG. 7 is an illustration of application management for multiple applications, according to certain embodiments. The system architecture illustrated in FIG. 7 may be directed to a template and application bundle management in a VW environment. The architecture may include a first management domain associated with cloud provisioning and orchestration of VWs, and a second management domain associated with template and application bundle management.

In the system architecture of FIG. 7, an EC2 VW instance (e.g., EC2 VM Hypori VW) may be associated with an AMI, which in turn may be associated with an EC2 launch template. The EC2 launch template may be linked to a VW template (e.g., Hypori VW Template), which may further be associated with one or more user groups. According to certain embodiments, the Hypori VW template may define configuration parameters, application availability, policies, or provisioning characteristics for one or more users within the associated user group.

In certain embodiments, the EC2 VW instance may be connected to one or more storage resources, including an EBS system volume, one or more additional EBS volumes, and a user data volume. In some embodiments, the EC2 VW instance may additionally access a read-only EFS resource. The read-only EFS resource may store shared application content, configuration data, application packages, or other resources accessible by one or more VW instances. Additionally, a cloud virtual workspace orchestration component (e.g., Cloud VW Orchestration) may coordinate deployment, lifecycle management, scaling, or configuration of the VW instances and associated templates.

As illustrated in FIG. 7, the second management domain may include a template and application management subsystem (e.g., Template and App Mgmt) configured to manage one or more application bundles, illustrated as App Bundle 1 through App Bundle N. In certain embodiments, the application bundles may include collections of applications, configuration files, dependencies, scripts, policies, or other executable or non-executable resources that may be selectively associated with VW templates.

As further illustrated in FIG. 7, an App Master component may serve as a source or parent repository for generating, maintaining, or versioning the plurality of application bundles. In certain embodiments, the application bundles may be independently managed and selectively associated with different VW templates or user groups.

According to certain embodiments, the application bundle data may be associated with the read-only EFS resource, thereby enabling one or more VW instances to access shared application resources without requiring duplication of the application content across multiple local storage volumes. In some embodiments, the template and application management subsystem may dynamically associate selected application bundles with a VW template during provisioning or runtime operations.

As illustrated in FIG. 7, the architecture separates two distinct management domains: a cloud provisioning and orchestration domain responsible for EC2 launch template management, AMI selection, WS instance lifecycle, and storage volume management; and a template and application bundle management domain responsible for Hypori VW template definitions, user group associations, and application bundle versioning and distribution. This separation enables independent lifecycle management of infrastructure provisioning and application content, such that application bundles may be updated or versioned without requiring changes to the underlying cloud infrastructure configuration.

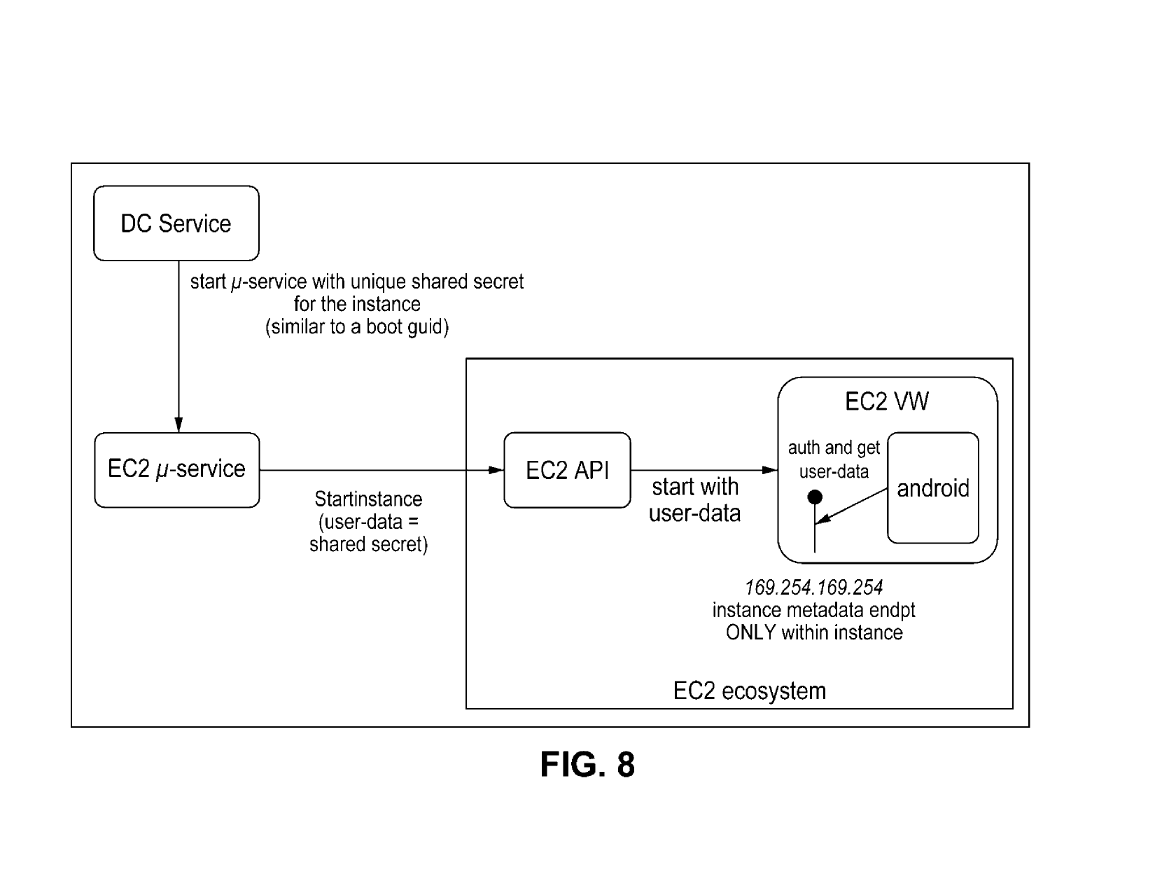

FIG. 8 illustrates an example system architecture, according to certain embodiments. In particular, FIG. 8 illustrates an example system architecture for securely provisioning and launching a VM instance within a cloud computing environment. As illustrated in FIG. 8, a data center (DC) service may initiate an instance-specific microservice (“μ-service”) associated with a VM instance. In some embodiments, the DC service may provide the μ-service with a unique shared secret corresponding to the instance, which may function similarly to a boot identifier or boot globally unique identifier (GUID).

According to certain embodiments, the system architecture may include an EC2 μ-service, which may communicate with a cloud provider API, such as an EC2 API, to initiate creation of an EC instance. As illustrated in FIG. 8, the instance may be launched using instance initialization data (e.g., user-data) that may include the shared secret. The cloud provider infrastructure may then starts an EC2 VM using the provided user-data.

In certain embodiments, within the instantiated VM, an application environment, illustrated as an Android environment, may authenticate and retrieves the user-data from the instance metadata endpoint. In certain embodiments, the metadata endpoint may be accessible from within the running instance, thereby limiting external access to the initialization data and associated shared secret. In some embodiments, the Android environment may use the retrieved shared secret to authenticate itself or establish trusted communications with external services.

In certain embodiments, the instance metadata endpoint used to retrieve the shared secret — illustrated in FIG. 8 as the 169.254.169.254 link-local address of the AWS Instance Metadata Service (IMDS) — may be accessible only from within the running EC2 instance and may not be reachable from external networks. This link-local address restriction may be a cloud-infrastructure-enforced security boundary that ensures the shared secret passed via user-data is accessible only to the running WS instance, contributing to the secure boot process without requiring additional encryption of the user-data payload.

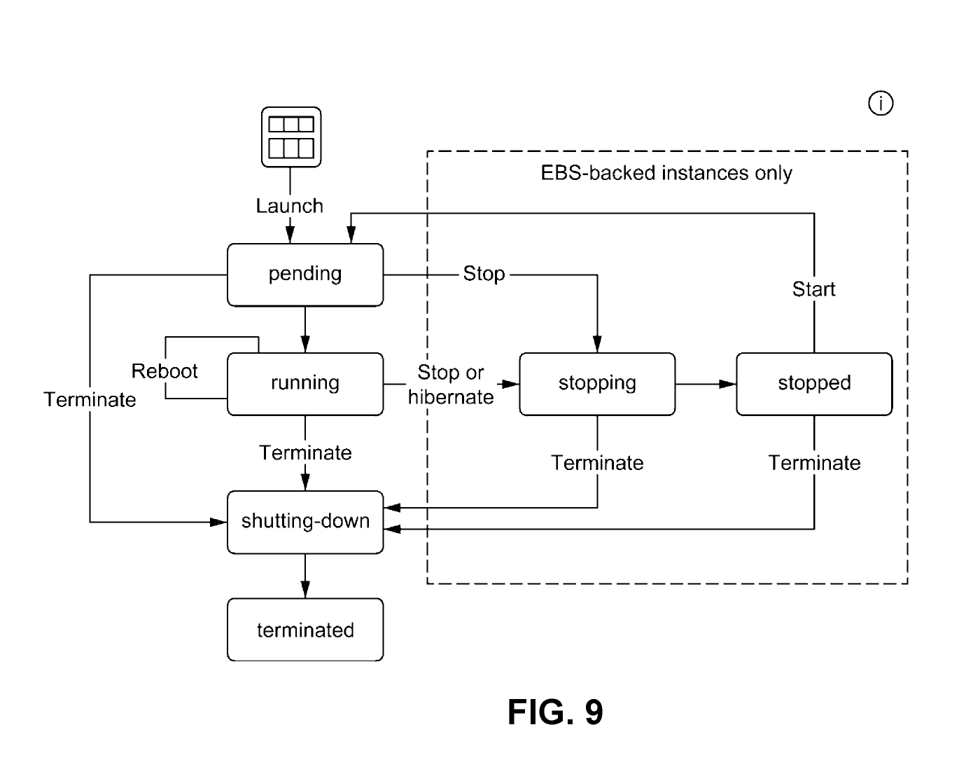

FIG. 9 illustrates example WS instance state transitions, according to certain embodiments. In certain embodiments, for example when hosted in the AWS public cloud, VM instances may maintain status and state as their lifecycle states at the infrastructure level. Certain embodiments may map the infrastructure lifecycle states to WS management states and reflect a subset of those in a management console.

As illustrated in FIG. 9, the transition from the running state may be initiated either as a stop operation, in which no instance memory state is preserved, or as a hibernate operation, in which the instance memory state is written to the attached EBS volume prior to stopping, enabling accelerated session resume upon the next connection request. In certain embodiments, the hibernate operation may be available only for EBS-backed instances, as indicated in FIG. 9. The ability to hibernate rather than stop the WS instance is a key mechanism for reducing session startup latency for returning users, as the operating system and application state are preserved and can be restored without a full boot sequence.

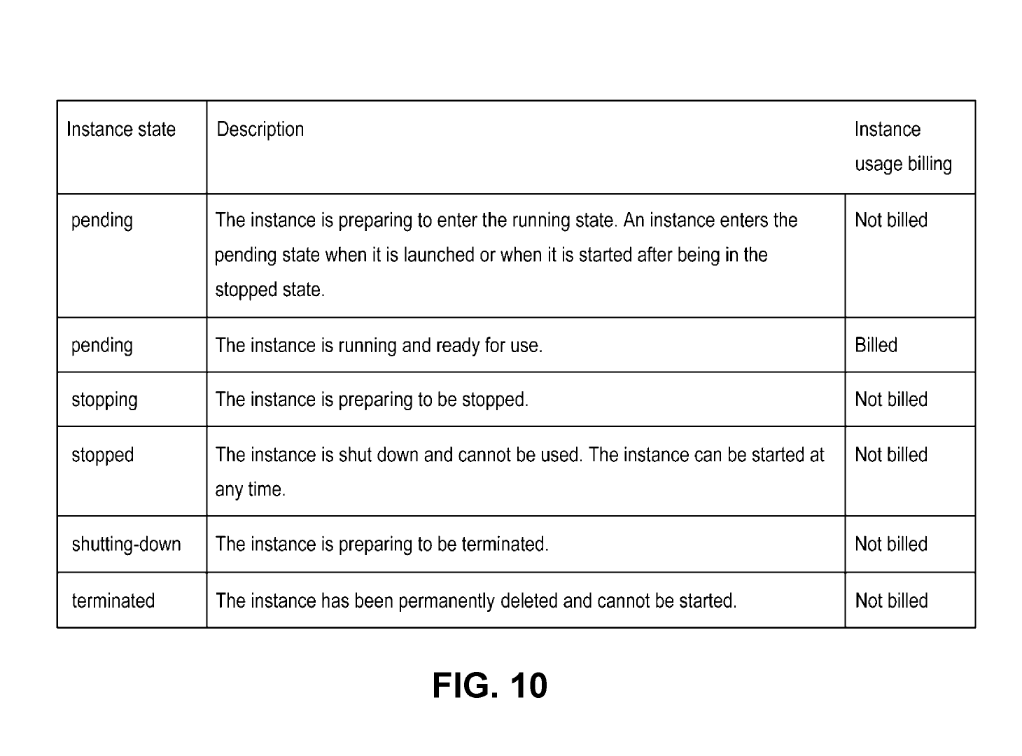

FIG. 10 illustrates an example of the cloud infrastructure VM instance states, according to certain embodiments. According to certain embodiments, there may be certain status checks that the WS goes through before it goes live and is usable. The status checks may be important sources of error/more detailed information if an instance gets into an error state. In certain embodiments, the system status checks may monitor the AWS system on which the instance runs. These checks may detect underlying problems with the instance that may require AWS involvement to repair. Examples of problems that may cause system status checks to fail may include, but not limited to, for example: loss of network connectivity; loss of system power; software issues on the physical host; and hardware issues on the physical host that impact network reachability.

In certain embodiments if a system status check fails, a StatusCheckFailed System metric may be incremented. According to certain embodiments, instance status checks may monitor the software and network configuration of an individual WS instance, and/or its underlying VM. For example, Amazon cloud may check the health of the instance by sending an address resolution protocol (ARP) request to the network interface (NIC). These checks may detect problems that require involvement to repair. When an instance status check fails, the problem may be addressed by, for example, rebooting the instance, or by making instance configuration changes.

The following may be examples of problems that can cause instance status checks to fail: failed system status checks; incorrect networking or startup configuration; exhausted memory; corrupted file system; and incompatible kernel.

In certain embodiments, when the cloud infrastructure VM system or WS instance status check fails, the StatusCheckFailed_System metric may be incremented. In some embodiments, the status check failure may be detected, and a determination may be made as to whether it is fatal or not. If status check failure is fatal, it may be captured in the allocated task line item and details may be added to it to show in the admin console task description.

As illustrated in FIG. 10, compute resources are billed by the cloud provider only when the WS instance is in the running state; the pending, stopping, stopped, shutting-down, and terminated states do not incur compute billing charges. In certain embodiments, this billing model may provide a direct cost optimization benefit from the hibernation mechanism: by transitioning inactive WS instances to a stopped state via hibernation, the system may eliminate ongoing compute charges for users who are not actively accessing their WS, while preserving the ability to resume quickly upon the next connection request.

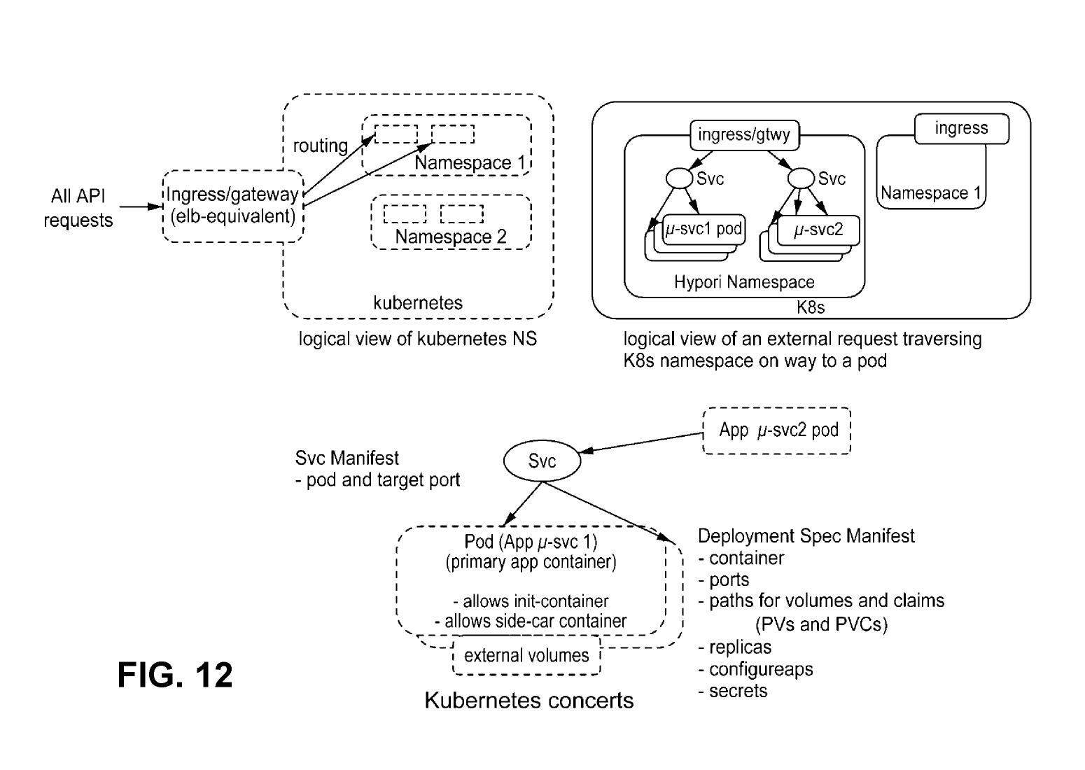

FIG. 12 illustrates an example Kubernetes-based microservices architecture for implementing the control plane, according to certain embodiments. As illustrated in FIG. 12, the architecture may include an ingress/gateway component configured to receive all external API requests and route them to appropriate services within Kubernetes namespaces. In certain embodiments, an external request may traverse the Kubernetes namespace by entering through the ingress/gateway and being routed to a target service within the Hypori namespace, which in turn routes the request to the appropriate microservice pod. According to certain embodiments, each application microservice may be deployed using a Deployment Specification Manifest specifying the container definition, port mappings, replica count, persistent volume claims (PVs and PVCs), configMaps, and secrets. Each deployed pod may include a primary application container and may optionally support sidecar containers and external volume mounts. In certain embodiments, each service within the Kubernetes cluster may be defined by a Service Manifest specifying the pod selector and target port, enabling the ingress/gateway to route traffic to the appropriate pod instance.

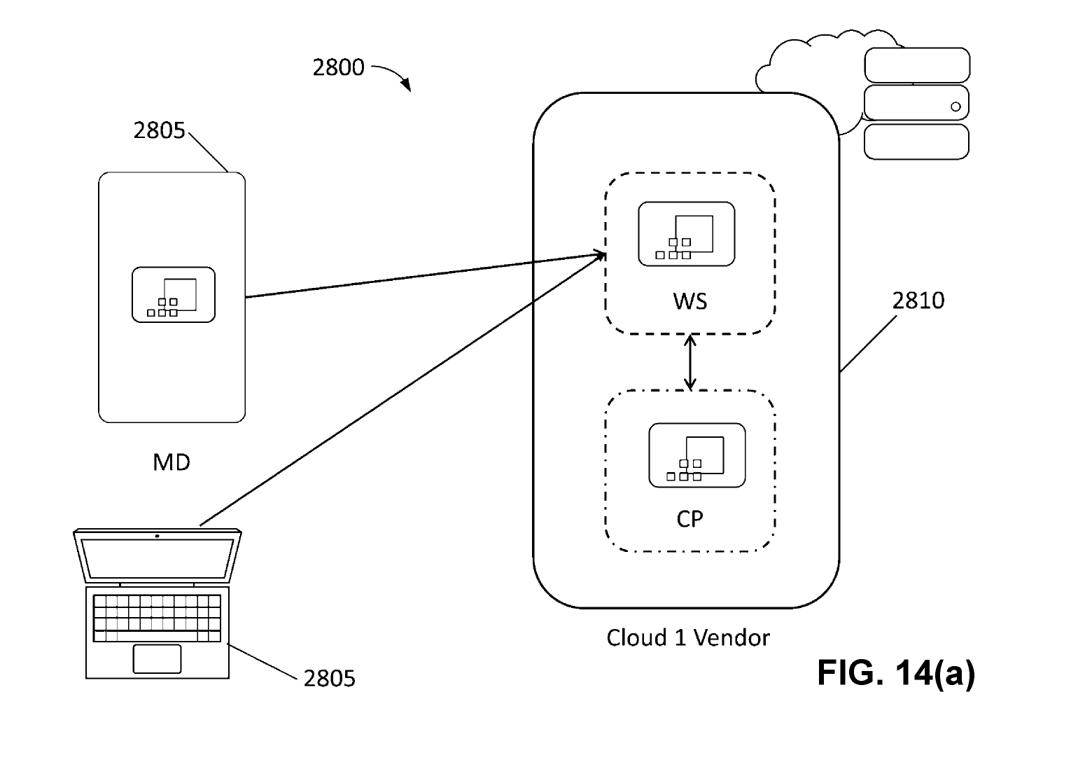

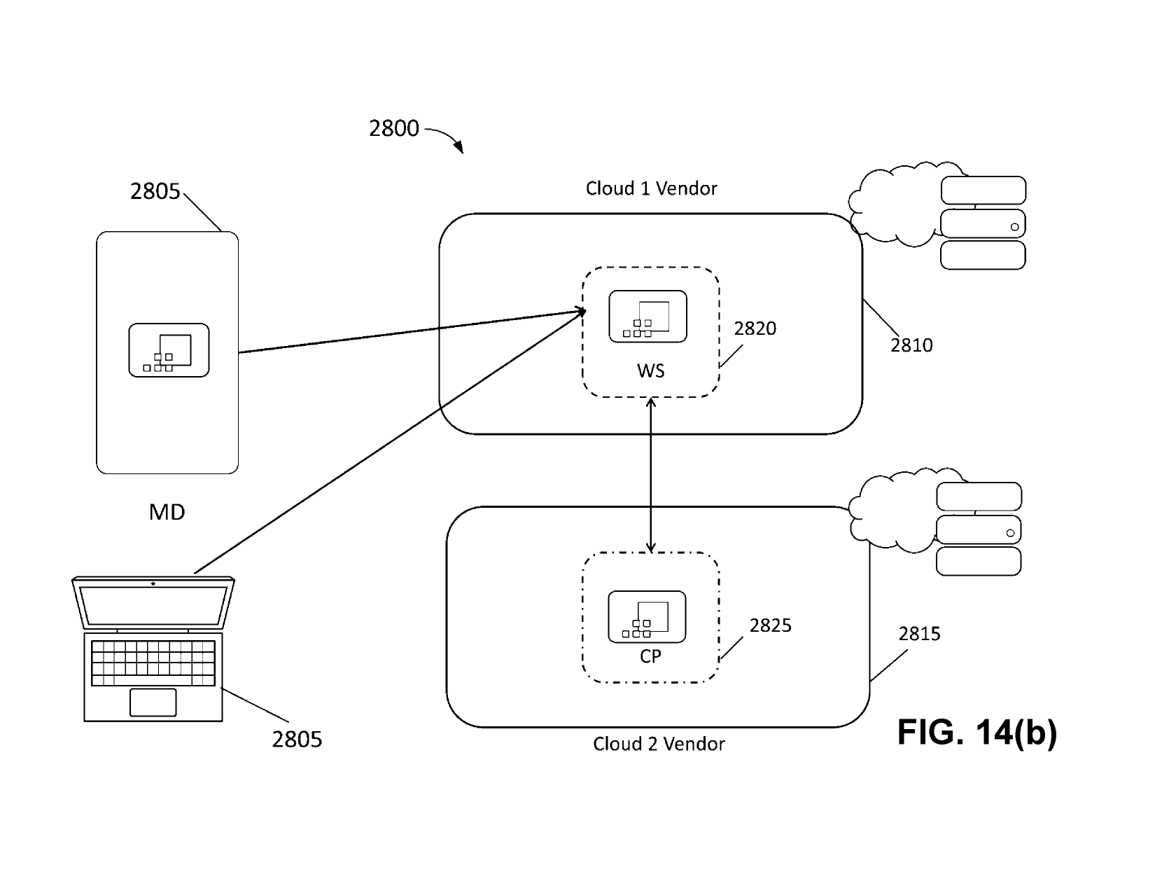

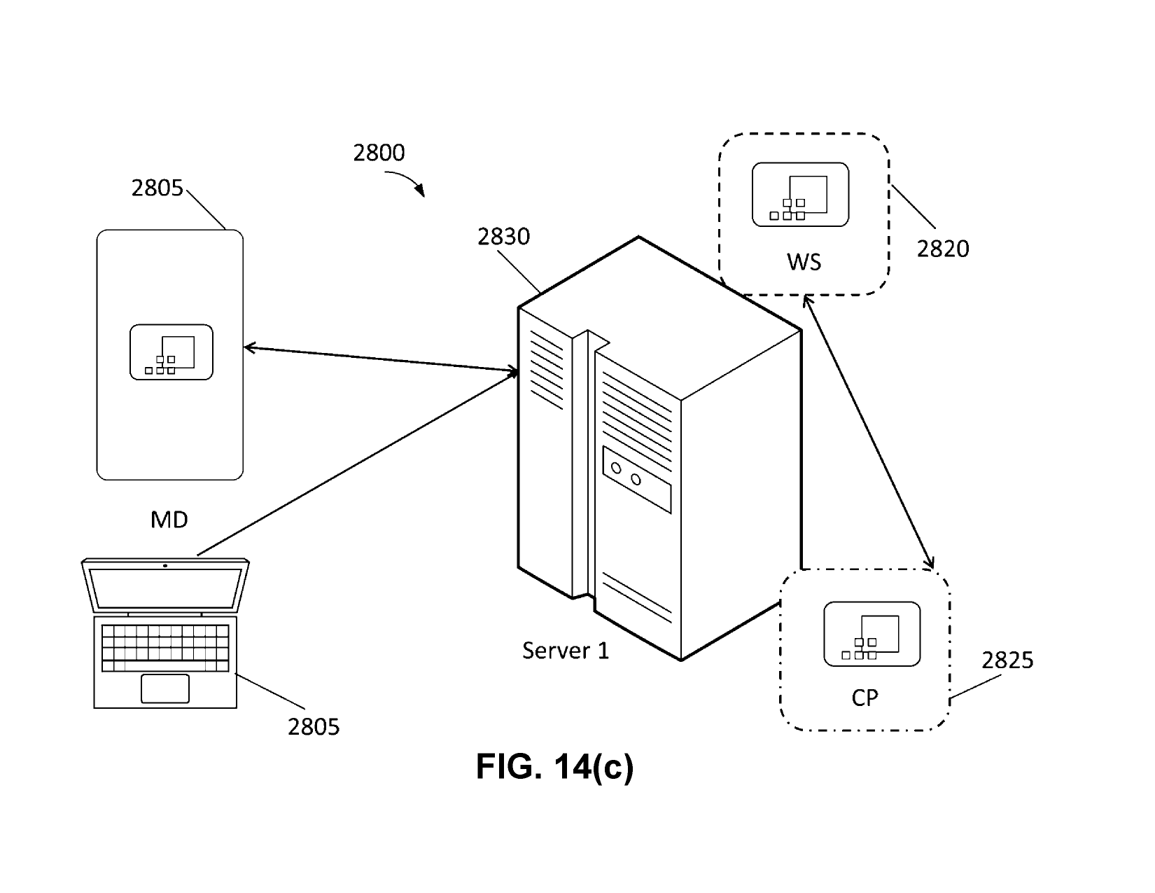

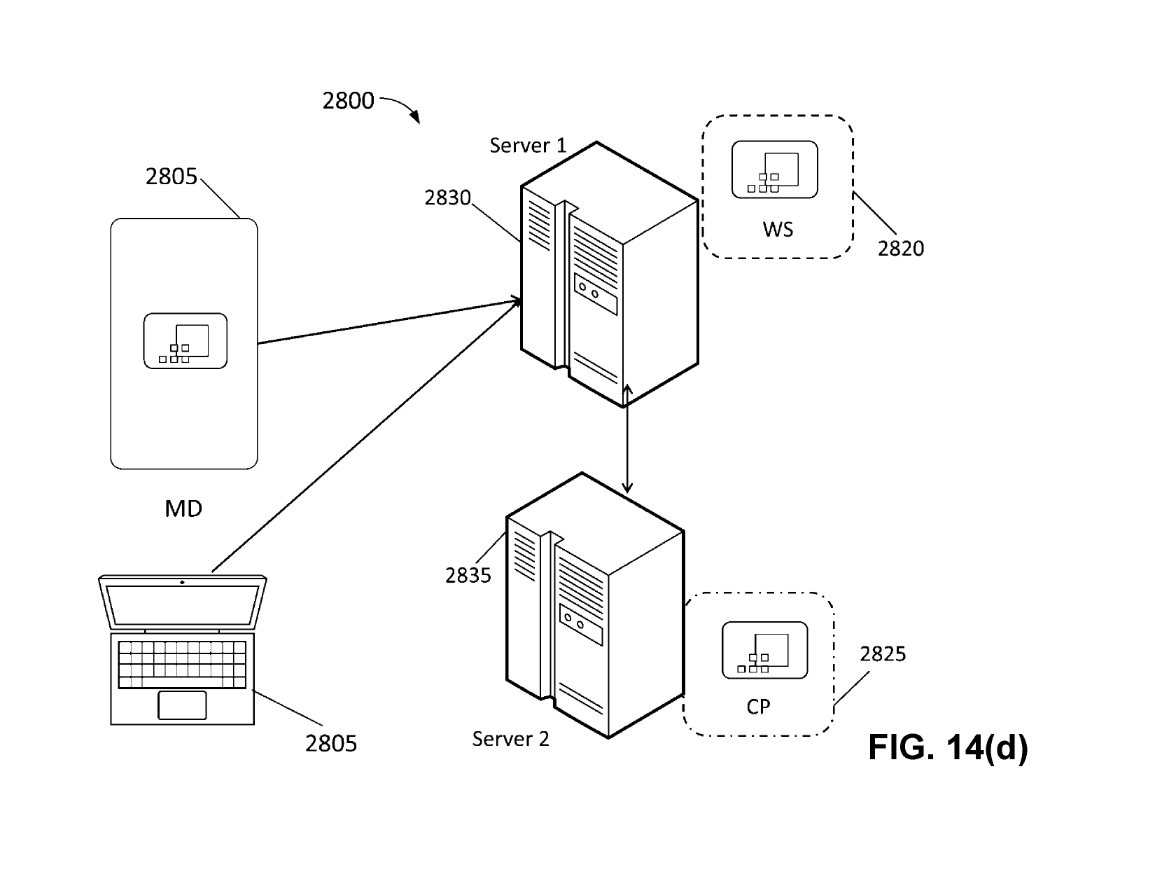

FIGS. 14(a)-14(d) illustrate example architectures of the system 2800, according to certain embodiments. As illustrated in FIGS. 14(a)-14(d), the system 2800 may include the MDs 2805, which may serve as a “window” to the WS 2820 and CP 2825 operating in the cloud 2810 and 2815, respectively. The system 2800 may be managed by a console/server 2830, 2835, and the console/server 2830, 2835 may configure, deploy, and/or manage users and virtual devices through the cloud 2810, 2815. According to certain embodiments, during operation, since the MD 2805 may interact with the WSs 2820 and 2825, no data is saved on the MD 2805. According to some embodiments, the system 2800 may be managed by a single console/server 2830 (FIG. 14(a) and 14(c)) or multiple consoles/servers 2830, 2835 (FIGS. 14(b) and 14(d)).

In some embodiments, the MD 2805 may be able to represent output from the WS 2820 via a combination of one or more output peripherals (such as, a screen, augmented/virtual reality display, generation of sound, haptic mechanisms, wearable device, etc.). In other embodiments, the MD 2805 may be able to forward user input to the WS 2820 obtained via a combination of one or more input peripherals (such as, a virtual or physical keyboard, microphone, touchscreen, etc.). Exchange of this information (e.g., output and/or input) between the MD 2805 and the WS 2820 may utilize an established connection (“session”). The capability for the MD 2805 to establish a session with the WS 2820 may be implemented in various embodiments, such as a dedicated app running on a general-purpose MD; functionality built into the operating system of a general-purpose MD; or purpose-built firmware/hardware.

Certain embodiments may provide well-defined contracts/APIs for platform services for 3rd-party to integrate. Certain embodiments may provide a system that is scalable, asynchronous, and has an observable cloud orchestration layer. Other embodiments may provide a cloud-agnostic layer working with cloud-specific service implementations for being able to work with multiple clouds.

According to certain embodiments, the system 2800 may use any conventional authentication protocol that enables secure communication between service providers and identity providers, including OpenID Connect (OIDC) or Security Assertion Markup Language (SAML). For example, an OIDC protocol may be provided for external authentication/authorization integrations, and other embodiments may be able to provide improved observability and monitoring for system and user security.

According to certain embodiments, the system 2800 can operate as Software as a Service (SaaS) or private deployment, in various cloud service/infrastructure provider or on-premises environments. The WS 2820 of the system 2800 may act as a secure WS 2820 that users can access from any authorized MD 2805 to process enterprise applications and data without causing any of the data to be persisted at rest on the MD 2805. In certain embodiments, the WS 2820 may be isolated from the user's MD 2805 or other personal device, protecting the user’s personal data on the MD 2805 from access by an organization by not requiring corporate/enterprise management of the user’s MD 2805.

In certain embodiments, both the CP 2825 and WS 2820 can be deployed as an on-premises solution or as a SaaS solution. With respect to a SaaS deployment, multiple WSs 2820 can be hosted in a single cloud service provider, or multiple WSs 2820 can be hosted in various cloud service providers. In some embodiments, the WS 2820 may be deployed in the same cloud service provider 2810 as the CP 2825, or both the WS 2820 and the CP 2825 can be deployed in separate cloud service providers. In certain embodiments, the CP 2825 may be the core component of the WS solution, acting as a central point for managing and securing access to enterprise applications and data from MDs 2805. In some embodiments, the CP 2825 may leverage a microservices-based architecture to offer robust scalability, automation, and efficient management of containerized applications, enhancing operational efficiency. The CP 2825 may also ensure virtual access to enterprise applications and data from any edge device is secure, while preserving end-user privacy and eliminating the mobile edge as a potential attack surface. In various embodiments, the CP 2825 may operate on a zero-trust principle, such that the CP 2825 does not trust any MD 2805 or user by default. This may ensure that even if an MD 2805 is compromised, the enterprise data remains secure within the WS 2820.

In certain embodiments, the MD 2805, WS 2820 and CP 2825 may utilize mutual Transport Layer Security (TLS) to create a secure communication pipeline between all communications of the MD 2805, WS 2820 , and CP 2825 for providing secure access to enterprise virtual applications, desktops, web and SaaS applications.

In certain embodiments, the WS solution may also have an enhanced boot process similar to an Android operating system’s hibernation state to speed up subsequent launches of the WS 2820 when the CP 2825 recognizes a request from a user that has previously communicated with and been validated by the CP 2825. The foregoing may provide significant improvements to the boot time for the WS 2820.

Certain embodiments may provide application management in real time for the applications hosted in the WS 2820, and provides the ability for these applications to receive updates and upgrades. This solution may also provide the ability to monitor a user’s usage of the underlying resources for the WS 2820, thus providing metering and elasticity. As an option, Artificial Intelligence (AI) or configured thresholds may be used to review and perform analysis of any data, detect the existing capabilities of the WS 2820 and its underlying environment, and provide the ability to automatically scale the resources required by a user’s WS 2820 (e.g., utilization, storage, bandwidth, etc.

Certain embodiments may also provide the WS with the ability to mimic the look and feel of any conventional MD (for example, screen size and resolution, behavior of touch interaction, display and arrangement of available apps, location of controls, etc.), based on a user’s identified preferences or the characteristics of the user’s MD.

According to certain embodiments, the WS may support voice and/or video communications, for example by voice over IP over addressable data networks; by e-sim using, for example, an embedded chipset emulator over traditional plain-switched telephone and cellular networks; or via other conventional or novel means.

In certain embodiments, the WS can provide an end-to-end secure messaging application for secure communications, or provide an option to communicate by Short Message Service (SMS), Rich Communication Services (RCS), etc. when a secure communication is not required by a user. In some embodiments, the communications solution may be deployed as a SaaS service.

In another embodiment, a user context associated with a WS may be saved to disk and disassociated from the WS after the WS session disconnects. The WS may then be released to a pool of WSs for use by the same or another MD, with the appropriate user’s context being associated with the WS upon session establishment. In some examples, one or more pools of WSs may be stored in the cloud and provisioned on receipt of a user context, which can reduce the time required to launch a WS session after a user logs in to an MD to request a new WS session.

Certain embodiments of the system may provide for a mechanism to process notifications sent by third party services to a WS on behalf of the WS while it is actually offline, powered down, or hibernated. Processing may include queuing for later delivery, forwarding to the MD while bypassing the WS so that users receive notifications without an established session between MD and WS, and/or sanitizing information included in notifications before making them available to the user.

Certain embodiments may explore how “hibernate” may work, and whether it may be a direct API call to WS or an API call to a cloud service provider. Under DC Service, sync statuses option may be implemented so that more than 1 DC Service can be run for scalability. Certain embodiments may provide a VM µ-service as part of CP. If cloud infrastructure credentials are not found, the VM µ-service does not star.

In certain embodiments, the name of the user may appear in an administrative console for creation of WSs. Further, an administrator or programmatic instruction via API may override the default region for deployment of a WS and/or MD session establishment, but only if the WS template is available in that region.

According to certain embodiments, for instance(s) status Instance Ids for started WSs, a status check for a WS instance may be fully ready after startup prior to a client authentication returning true. Under this example, a live check (started) may be initiated, and a readiness check may be implemented to take traffic (2 status checks). In certain embodiments, the WS instances may have a state that may be running but not ready. Thus, there may be a need to check the instance state as well as the instance status.

In certain embodiments, the initializing and running statuses for a WS instance may represent different stages in the instance’s lifecycle. Under initialization, when a WS instance is in the “initializing” state, it indicates that the instance is in the process of booting up, initializing its operating system, and preparing to become fully operational. During this phase, the instance may be undergoing various checks and configurations to ensure that it can handle incoming network traffic and perform its intended functions. If it is not fully operational, it may not be ready to accept incoming requests or connections.

According to certain embodiments, once a WS instance has finished initializing, it may enter the “running” state where the instance is up and running, fully operational, and ready to handle incoming requests and perform its intended functions. In this state, the instance’s operating system may be fully booted, and the instance may be accessible for use.

In certain embodiments, the discrepancy between the “running” state and the “initializing” status may occur due to the fact that the instance has completed its boot process and is technically running, but it may still be finalizing its initialization and not fully be ready to accept incoming connections or requests. This may lead to a situation where the instance is in the “running” state but is not yet fully operational, as indicated by the “initializing” status check. It is important to monitor both the instance state and status checks to ensure that the instance is fully operational and ready to handle workloads.

According to certain embodiments, the WS 2820 may support voice and/or video communications, for example by voice over IP over addressable data networks, or by e-sim using, for example, an embedded chipset emulator over traditional plain-switched telephone and cellular networks.

In certain embodiments, the WS 2820 can provide an end-to-end secure messaging application for secure communications, or provide an option to communicate by Short Message Service (SMS), Rich Communication Services (RCS), etc. when a secure communication is not required by a user. In some embodiments, the communications solution may be deployed as a SaaS service.

In another embodiment, a user context associated with a WS 2820 may be saved to disk and disassociated from the WS 2820 after the WS session disconnects. The WS 2820 may then be released to a pool of WSs 2820 for use by the same or another MD 2805, with the appropriate user’s context being associated with the WS 2820 upon session establishment. In some examples, one or more pools of WSs 2820 may be stored in the cloud and provisioned on receipt of a user context, which can reduce the time required to launch a WS session after a user logs in to an MD 2805 to request a new WS session.

In another embodiment, the system 2800 may use segmented network traffic to provide secure access from the MD 2805 to enterprise virtual apps, desktops, web and SaaS apps on the WS 2820. For example, the network traffic to and from the WS 2820 may be separated into distinct network segments/subnets to provide further security, and the display network may convey traffic from the MD 2805 to the WS 2820. In certain embodiments, the enterprise network may convey traffic from the WS 2820 to enterprise resources (e.g., corporate resources) of a consumer. For added security, crossing network segments/subnets may be tightly controlled by use of security groups, and further security may be provided by segment level API gateways which expose only a relevant set of APIs for that network’s use case. In certain example embodiments, traffic between the client and the virtual workspace may include only gesture and sensor information from the client to the virtual workspace, and encrypted pixels and sound from the virtual workspace to the client. All traffic that originates from the virtual phone may pass through a separate network route distinct from the above network. This enables true separation between enterprise data residing in the virtual workspace from the physical phone. Similarly, management of a platform that sits on a distinct separate network may improve security posture. In certain example embodiments, traffic in all networks may require both sides to be verified and authorized before communication can be established (mutual TLS is an example of such protocol). In some alternatives, the segmented network traffic may provide security by dividing a network into smaller, isolated segments, preventing attackers from easily moving laterally if they compromise a single segment. For example, network traffic between the MD 2805 and WS 2820 may occur via a separate network that could be labelled the “Display Network.” Network traffic between the CP 2825 and enterprise virtual apps, desktops, web and SaaS apps on the WS may occur via a separate network, labelled the “Enterprise Network.” Communication between the ”Display Network” and the “Enterprise Network” can occur via another separate network, known as the “Management Network.” The foregoing may ensure that there is no direct communication between the MD 2805 and the enterprise virtual apps, desktops, web and SaaS apps on the WS 2820. In some examples, the separate networks may be managed by one or more firewalls and/or other methods to segregate information flows; and WSs 2820 in the same network segment may be allowed to communicate with each other or may be completely segregated from each other.

Certain embodiments of the system 2800 may provide a mechanism to process notifications sent by third party services to a WS 2820 on behalf of the WS 2820 while it is offline, powered down, or hibernating. Processing may include, for example, queuing for later delivery, forwarding to the MD 2805 while bypassing the WS 2820 so that users receive notifications without an established session between MD 2805 and WS 2820, and/or sanitizing information included in notifications before making them available to the user.

As illustrated in FIGS. 14(a)-14(d), the MD 2805 can be a touchscreen smartphone with local device functions such as the touch screen, the dialer/phone network, camera, Global Positioning System (GPS), keyboard, speakers, microphone, and so on. Other examples of mobile device 2805 may include touchscreen tablets and other touch-enabled mobile devices. As will be explained in further detail below, such mobile device functions can be provided by embodiments disclosed herein on protected hardware and software in cloud 2810 without adversely affecting the user's experience in interacting with mobile device 2805. Further, mobile devices 2805 may be programmed with different operating systems such as iOS, Android, and Windows. Each of mobile device 2805 may have a virtual client (VC) client application installed, for instance, by an administrator or IT personnel of system 2800. In one embodiment, a VC client application may be downloaded from an online device-specific app store.

In one embodiment, a VC client application may include software that brokers access to mobile devices' physical interfaces (e.g., soft and hard keyboards, touchscreen, GPS, camera, accelerometer, speakers, microphone, phone dialer, etc.) and Virtual Private Network (VPN) software that connects across a public network such as the Internet to servers in a virtualization cloud over encrypted network interfaces. In some embodiments, the VC 2810 may provide a hosted, networked, application environment. As a non-limiting example, in one embodiment, cloud 2810 may be configured as an Android application environment.

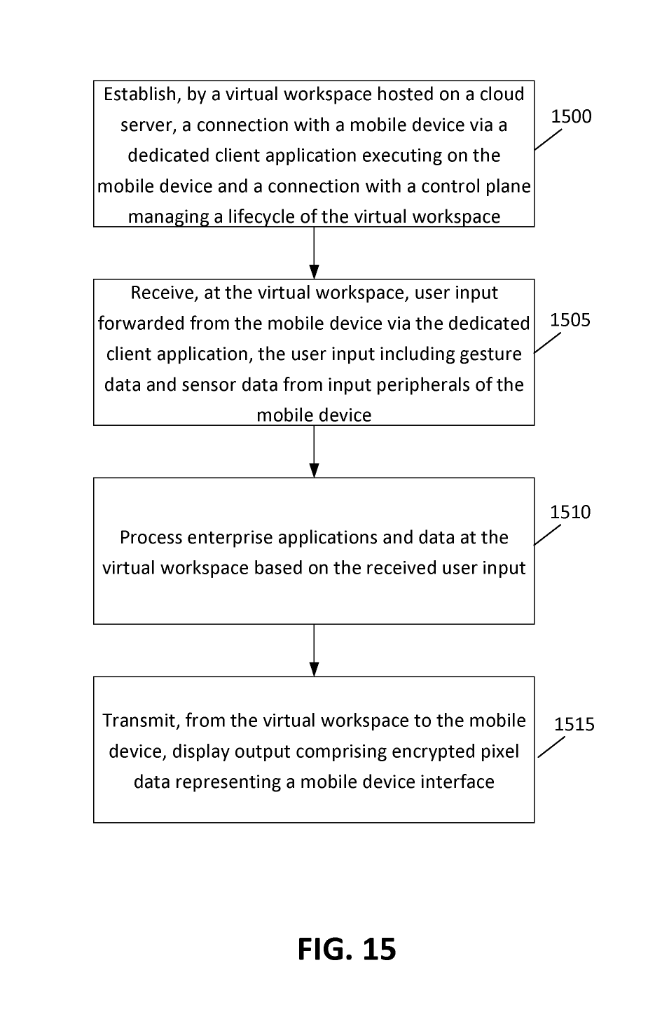

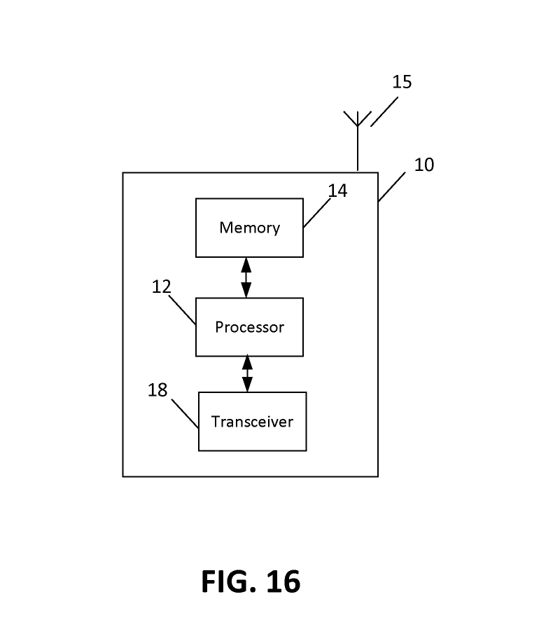

FIG. 15 illustrates an example flow diagram of a method, according to certain example embodiments. In an example embodiment, the method of FIG. 15 may be performed by a network entity, or a group of multiple network elements in a network system. For instance, in an embodiment, the method of FIG. 15 may be performed by a WS, similar to apparatus 10 illustrated in FIG. 16.

As illustrated in FIG. 15, the method may include, at 1500, establishing, by a virtual workspace hosted on a cloud server, a connection with a mobile device via a dedicated client application executing on the mobile device and a connection with a control plane managing a lifecycle of the virtual workspace, wherein the virtual workspace may be isolated from the mobile device.

At 1505, the method may include receiving, at the virtual workspace, user input forwarded from the mobile device via the dedicated client application, the user input comprising at least one of gesture data or sensor data from one or more input peripherals of the mobile device, and processing, at the virtual workspace, enterprise applications and data based on the received user input.

At 1510, the method may include transmitting, from the virtual workspace to the mobile device, display output comprising encrypted pixel data representing a mobile device interface executing on the virtual workspace, wherein no enterprise data may be persisted at rest on the mobile device.

According to certain embodiments, the method may also include supporting, at the virtual workspace, at least one of voice communications, Short Message Service (SMS), or eSIM functionality, such that the virtual workspace provides telephony capabilities accessible via the mobile device without the telephony data residing on the mobile device. According to some embodiments, transmitting the display output may include transmitting via a first network segment, and the virtual workspace may communicate with enterprise resources via a second network segment distinct from the first network segment, such that the mobile device and the enterprise resources communicate through separate, non-directly-interconnected network segments.

FIG. 16 illustrates an apparatus 10, according to an embodiment. In certain example embodiments, apparatus 10 may be an element in a communications network, computer network, or associated with such a network. For example, apparatus 10 may be a computer, mobile device, or server. In certain example embodiments where apparatus 10 is implemented as a cloud server, apparatus 10 may not include radio access components such as antennas or transceivers. In such embodiments, communications may be performed over wired or virtual network interfaces. In other embodiments where apparatus 10 represents a mobile device or edge device, apparatus 10 may include radio access components as described below.

In some example embodiments, apparatus 10 may include one or more processors 12, one or more computer-readable storage medium 14 (for example, memory, storage, or the like), one or more radio access components (for example, a modem, a transceiver, or the like), and/or a user interface. It should be noted that one of ordinary skill in the art would understand that apparatus 10 may include components or features not shown in FIG. 16.

As illustrated in the example of FIG. 16, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processor 12 is shown in FIG. 16, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-15.

Apparatus 10 may further include or be coupled to a memory 14 (internal or external), which may be respectively coupled to processor 12 for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-15.

In some example embodiments, apparatus 10 may also include or be coupled to one or more antennas 15 for receiving a signal and for transmitting signals from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 18 may be configured to modulate information on to a carrier waveform for transmission by the antenna 15 and demodulate information received via the antenna 15 for further processing by other elements of apparatus 10. In other embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain embodiments, apparatus 10 may optionally be configured to communicate with other similar apparatuses (in any combination) via a wireless or wired communication links.

According to certain example embodiments, processor 12 and memory 14 may be included in or may form a part of processing circuitry or control circuitry. In addition, in some example embodiments, transceiver 18 may be included in or may form a part of transceiving circuitry.

In other example embodiments, apparatus 10 may be controlled by memory 14 and processor 12 to establish a connection with a mobile device via a dedicated application implemented on the mobile device, and a connection with a control plane. According to certain example embodiments, the apparatus may be implemented in a cloud server and is isolated from the mobile device. Apparatus 10 may also be controlled by memory 14 and processor 12 to receive user input forwarded from the mobile device via the dedicated application, the user input comprising gesture data and sensor data from input peripherals of the mobile device. Apparatus 10 may further be controlled by memory 14 and processor 12 to process enterprise applications and data based on the received user input, wherein no enterprise data may be persisted at rest on the mobile device. Additionally, apparatus 10 may be controlled by memory 14 and processor 12 to transmit display output to the mobile device including encrypted pixel data representing a mobile device interface executing on the apparatus.

In some example embodiments, an apparatus (e.g., apparatus 10) may include means for performing a method, a process, or any of the variants discussed herein. Examples of the means may include one or more processors, memory, controllers, transmitters, receivers, and/or computer program code for causing the performance of the operations.

Other example embodiments may be directed to an apparatus that includes means for establishing a connection with a mobile device via a dedicated application implemented on the mobile device and means for establishing a connection with a control plane, wherein the apparatus may be hosted on a cloud server and is isolated from the mobile device. The apparatus may also include means for receiving user input forwarded from the mobile device including gesture data and sensor data from input peripherals of the mobile device. The apparatus may further include means for processing enterprise applications and data based on the received user input, wherein no enterprise data may be persisted at rest on the mobile device. Additionally, the apparatus may include means for transmitting display output to the mobile device comprising encrypted pixel data representing a mobile device interface executing on the apparatus.

Certain example embodiments described herein provide several technical improvements, enhancements, and/or advantages. For instance, in some example embodiments, it may be possible to provide significant improvements to the boot time for the WS. In other embodiments, it may be possible for the applications to receive updates and upgrades, and provide the ability for the system to monitor a user’s usage of the underlying resources for the WS, thereby providing metering and elasticity.

In certain embodiments, enterprise data may never persisted at rest on the mobile device, eliminating device-level data exposure even in the event of device loss, theft, or compromise — an improvement over MDM and MAM solutions that rely on securing data stored on the device.

In certain embodiments, the system may preserve user privacy by eliminating the need for enterprise management or monitoring of the user's personal mobile device, which is an improvement over MDM solutions that require device enrollment and may expose personal data to enterprise oversight.

In certain embodiments, the mobile edge may be eliminated as a potential attack surface, such that compromise of the mobile device does not expose enterprise applications or data — an improvement over containerization approaches where application data remains on the device.

In certain embodiments, the virtual workspace may provide a full mobile phone experience including telephony capabilities such as voice over IP, SMS, and eSIM via an embedded chipset emulator, distinguishing the system from virtual desktop solutions that do not replicate mobile phone functionality.

In certain embodiments, the segmented network architecture may ensure no direct communication path exists between the mobile device and enterprise resources, providing defense-in-depth that is not present in unified-network virtual desktop infrastructure deployments.

In certain embodiments, the zero-trust model may ensure access is granted only upon successful authentication and authorization regardless of device state, an improvement over perimeter-based security models that trust devices within a network boundary.

In certain embodiments, the cloud-agnostic architecture may enable deployment across multiple cloud providers or on-premises environments without modification, providing operational flexibility not available in cloud-vendor-specific virtual workspace solutions.

In certain embodiments, cloud compute costs may be reduced by hibernating the virtual workspace when not in use, transitioning the compute instance to a stopped state in which compute billing does not accrue, an improvement over solutions that maintain persistent running virtual machines.

Although the invention has been described with respect to specific embodiments thereof, these embodiments are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to "one embodiment", "an embodiment", or "a specific embodiment" or similar terminology means that a particular feature, structure, or characteristic described in connection with the embodiment is included in at least one embodiment and may not necessarily be present in all embodiments. Thus, respective appearances of the phrases "in one embodiment", "in an embodiment", or "in a specific embodiment" or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit ("CPU"), at least one read-only memory ("ROM"), at least one random access memory ("RAM”), at least one hard drive ("HD"), and one or more input/output ("I/O") device(s). The I/O devices can include a keyboard, monitor, printer, electronic pointing device (for example, mouse, trackball, stylus, touch pad, etc.), or the like. In embodiments of the invention, the computer has access to at least one database over the network.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term "computer readable medium" is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A "computer-readable medium" may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A "processor" includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in "real-time," "offline," in a "batch mode," etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted.

As used herein, the terms "comprises," "comprising," "includes," "including," "has," "having," or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term "or" as used herein is generally intended to mean "and/or" unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by "a" or "an" (and "the" when antecedent basis is "a" or "an") includes both singular and plural of such term, unless clearly indicated within the claim otherwise (i.e., that the reference "a" or "an" clearly indicates only the singular or only the plural). Also, as used in the description herein and throughout the claims that follow, the meaning of "in" includes "in" and "on" unless the context clearly dictates otherwise. The scope of the present disclosure should be determined by the following claims and their legal equivalents.

We claim:

1. An apparatus, comprising:
at least one processor; and
at least one memory storing instructions which, when executed by the at least one processor, cause the apparatus to at least:
establish a connection with a mobile device via a dedicated application implemented on the mobile device, and a connection with a control plane, wherein the apparatus is hosted on a cloud server and is isolated from the mobile device;
receive user input forwarded from the mobile device via the dedicated application, the user input comprising gesture data and sensor data from input peripherals of the mobile device;
process enterprise applications and data based on the received user input, wherein no enterprise data is persisted at rest on the mobile device; and
transmit display output to the mobile device comprising encrypted pixel data representing a mobile device interface executing on the apparatus.

2. The apparatus according to claim 1, wherein the display output transmitted from the apparatus to the mobile device further comprises audio data, such that no application logic or enterprise data traverses from the apparatus to the mobile device outside of the display output.

3. The apparatus according to claim 1, wherein the instructions, when executed by the at least one processor, further cause the apparatus to support at least one of:
voice over IP communications, Short Message Service (SMS), Rich Communication Services (RCS), or an embedded subscriber identity module (eSIM) implemented via a chipset emulator, such that telephony capabilities of the apparatus are accessible to a user via the mobile device without the telephony data or functionality residing on the mobile device.

4. The apparatus according to claim 1, wherein communications between the apparatus and the mobile device, between the apparatus and the control plane, and between the mobile device and the control plane each utilize mutual Transport Layer Security (mTLS), such that both parties on each communication leg are required to present and verify certificates before a connection is established.

5. The apparatus according to claim 1, wherein the control plane operates under a zero-trust model in which neither the mobile device nor any user is trusted by default, and access to the apparatus is granted only upon successful authentication and authorization through the control plane.

6. The apparatus according to claim 1,
wherein network traffic between the mobile device and the apparatus is confined to a first network segment,
wherein network traffic between the apparatus and enterprise resources is confined to a second network segment distinct from the first network segment, and
wherein management traffic between the control plane and the apparatus is confined to a third network segment distinct from the first and second network segments, such that no direct communication path exists between the mobile device and the enterprise resources.

7. The apparatus according to claim 1, wherein the apparatus and the control plane are deployable across a plurality of cloud service providers or on-premises environments without modification to apparatus or control plane configuration specific to any single cloud service provider.

8. The apparatus according to claim 1,
wherein the control plane maintains a pool of compute instances in a partially-booted state, and
wherein a session for a user is established by associating a user data volume with an available instance from the pool, and
wherein the user data volume comprises user-specific applications, settings, and data, such that the time to establish a session is reduced relative to initializing a new compute instance from an unbooted state.

9. The apparatus according to claim 1, wherein the apparatus is configurable
to enter a hibernation state in which no compute resources of the cloud server are consumed, and
to resume from the hibernation state in an accelerated boot process that restores a prior session state of the apparatus.

10. The apparatus according to claim 1, wherein the apparatus and the control plane are deployable as a Software as a Service (SaaS) solution or as an on-premises deployment within an enterprise network, and wherein multiple apparatuses are hostable within a single cloud service provider or distributed across multiple cloud service providers.

11. The apparatus according to claim 1,
wherein the mobile device is a smartphone or tablet running any of a plurality of mobile operating systems, and
wherein the dedicated application enables the mobile device to serve as a display and input interface for the apparatus independent of the operating system of the mobile device.

12. The apparatus according to claim 1, wherein the instructions, when executed by the at least one processor, further cause the apparatus to:
replicate user interface characteristics of the mobile device comprising at least one of screen size, screen resolution, touch interaction behavior, application arrangement, or control placement, based on characteristics of the mobile device or user preferences.

13. The apparatus according to claim 1, wherein the control plane is configured
to receive notifications directed to the apparatus while the apparatus is in an offline or hibernated state, and
to at least one of: queue the notifications for delivery upon the apparatus becoming active, forward the notifications to the mobile device while bypassing the apparatus, or sanitize information in the notifications prior to delivery.

14. A method comprising:
establishing, by a virtual workspace hosted on a cloud server, a connection with a mobile device via a dedicated client application executing on the mobile device and a connection with a control plane managing a lifecycle of the virtual workspace, wherein the virtual workspace is isolated from the mobile device;
receiving, at the virtual workspace, user input forwarded from the mobile device via the dedicated client application, the user input comprising gesture data and sensor data from input peripherals of the mobile device;
processing enterprise applications and data at the virtual workspace based on the received user input; and
transmitting, from the virtual workspace to the mobile device, display output comprising encrypted pixel data representing a mobile device interface, wherein no enterprise data is persisted at rest on the mobile device.

15. The method of claim 14, further comprising supporting, at the virtual workspace, at least one of voice communications, Short Message Service (SMS), or eSIM functionality, such that the virtual workspace provides telephony capabilities accessible via the mobile device without the telephony data residing on the mobile device.

16. The method of claim 14,
wherein transmitting the display output comprises transmitting via a first network segment, and
wherein the virtual workspace communicates with enterprise resources via a second network segment distinct from the first network segment, such that the mobile device and the enterprise resources communicate through separate, non-directly-interconnected network segments.

17. A system comprising:
a mobile device executing a dedicated client application;
a virtual workspace hosted on a cloud server and isolated from the mobile device, the virtual workspace configured to process enterprise applications and data, and to transmit display output representing a mobile device interface to the mobile device; and
a control plane configured to manage a lifecycle of the virtual workspace,
wherein the mobile device forwards user input to the virtual workspace via the dedicated client application, and wherein no enterprise data is persisted at rest on the mobile device.
